(19) United States
(12) Patent Application Publication
(10) Pub. No.: US 2018/0084231 A1
(43) Pub. Date: Mar. 22, 2018

(54) MACHINE VISION SPECTRAL IMAGING

(71) Applicant: TruTag Technologies, Inc., Kapolei, HI (US)

(72) Inventors: Timothy Learmonth, Berkeley, CA (US); Ron R. Nissim, El Cerrito, CA (US); Hod Finkelstein, Berkeley, CA (US); Mark Hsu, Richmond, CA (US)

(21) Appl. No.: 15/709,365

(22) Filed: Sep. 19, 2017

Related U.S. Application Data
(60) Provisional application No. 62/397,877, filed on Sep. 21, 2016.
(60) Provisional application No. 62/416,843, filed on Nov. 3, 2016.
(60) Provisional application No. 62/421,873, filed on Nov. 14, 2016.

(51) Int. Cl. H04N 9/083; G06T 7/80; H04N 5/225; G06T 7/00

(52) U.S. Cl. CPC H04N 9/083; G06T 7/80; H04N 5/2256; G06T 2207/30128; G06T 2207/10024; G06T 2207/30164; G06T 7/0004

(57) ABSTRACT

A system for machine vision spectral imaging includes a spectral imager, a substrate, and a processor. The spectral imager comprises a Fabry-Perot etalon including a settable gap. The substrate has relative motion with respect to the spectral imager. The processor is configured to identify an object in a set of images from the spectral imager, wherein each of the set of images is associated with a specific gap of a full set of gaps, wherein the full set of gaps comprises a set of gaps setting the settable gap covering a complete range of the settable gap needed for a full spectral image of the object.

### CROSS REFERENCE TO OTHER APPLICATIONS

This application claims priority to U.S. Provisional Patent Application No. 62/397,877 (Attorney Docket No. CBIOP021+) entitled MACHINE VISION SPECTRAL IMAGER filed Sep. 21, 2016 which is incorporated herein by reference for all purposes.

This application also claims priority to U.S. Provisional Patent Application No. 62/416,843 (Attorney Docket No. CBIOP022+) entitled HYPERSPECTRAL IMAGING OF MOVING OBJECTS SUITABLE FOR MACHINE VISION APPLICATIONS filed Nov. 3, 2016 which is incorporated herein by reference for all purposes.

This application also claims priority to U.S. Provisional Patent Application No. 62/421,873 (Attorney Docket No. CBIOP024+) entitled HYPERSPECTRAL IMAGING OF MOVING OBJECTS SUITABLE FOR MACHINE VISION APPLICATIONS filed Nov. 14, 2016 which is incorporated herein by reference for all purposes.

### BACKGROUND OF THE INVENTION

Hyperspectral imaging of objects moving on a conveyor in a production line is extremely useful for multiple application areas including food processing and quality control. No technology can currently achieve this in a cost-effective way. Furthermore, tuning the spectral range of such cameras such that they can scan one set of wavelengths for a certain product line, and then be easily reconfigured to scan a different set of wavelengths of a different product line has not yet been possible. In some existing instruments, a tunable filter is able to select up to 3 reflected spectral bands and image them onto an area RGB sensor. In some cases, there is also a problem in that the light flux per pixel tends to be very low because of inherent losses in the system. The source light is spread over the whole imaged area, then only a narrow angular band of light is collected and later only up to 3 very narrow spectral bands are collected. Consequently, integration time needs to be relatively long which contradicts the need for fast acquisition in machine vision applications.

### BRIEF DESCRIPTION OF THE DRAWINGS

Various embodiments of the invention are disclosed in the following detailed description and the accompanying drawings.

FIG. 1 is a block diagram illustrating an embodiment of a system for machine vision spectral imaging.

FIG. 2A is a block diagram illustrating an embodiment of a spectral imager.

FIG. 2B is a block diagram illustrating an embodiment of a spectral imager.

FIG. 2C is a block diagram illustrating an embodiment of a spectral imager.

FIG. 3 is a block diagram illustrating an embodiment of a processor.

FIGS. 4A, 4B, and 4C are block diagrams illustrating objects moving on a substrate.

FIG. 5 is a flow diagram illustrating an embodiment of a process for machine vision spectral imaging.

FIG. 6 is a flow diagram illustrating an embodiment of a process for taking a spectral image.

FIG. 7 is a flow diagram illustrating an embodiment of a process for determining a spectral object map.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for machine vision spectral imaging is disclosed. The system includes a spectral imager, a substrate, and a processor. The spectral imager comprises a Fabry-Perot etalon including a settable gap. The substrate has relative motion with respect to the spectral imager. The processor is configured to identify an object in a set of images from the spectral imager, wherein each of the set of images is associated with a specific gap of a full set of gaps. The full set of gaps comprises a set of gap settings, wherein the settable gaps cover a complete range of the settable gaps needed for a full spectral image of the object. In some embodiments, the processor is coupled to a memory that is configured to store instructions.

Hyperspectral imaging of objects moving on a conveyor on a production line is extremely useful for multiple application areas including food processing and quality control. However, current technology cannot achieve this in a cost-effective way. Furthermore, it has not been possible to tune the spectral range of current hyperspectral cameras such that they can scan one set of wavelengths for a certain product line, and then be easily reconfigured to scan a different set of wavelengths for a different product line.

In the following, the terms ‘tunable Fabry-Perot etalon’, ‘Fabry-Perot etalon’, ‘tunable FPI’ and ‘FPI’ (i.e., Fabry-Perot Interferometer) are used interchangeably.

A scanning Fabry-Perot etalon camera is programmed to scan a sequence of mirror gaps continuously (either in one direction using a sawtooth function or in circular fashion using a triangular waveform of gaps as a function of time, or using any other sequence of gaps). An image or linear sensor captures frames in a synchronous manner to the gap positions. A light source which can emit at least the expected wavelengths to be captured by the Fabry-Perot etalon illuminates a moving substrate (e.g. a conveyor belt) carrying objects. Each captured image is indexed such that the gap position corresponding to it is recorded. An image processing algorithm identifies objects in each frame and indexes them as they change position in a frame. The gap scan speed is such that the time it takes an object to pass from one edge of an image to the other edge is longer or equal to the time required to scan all gaps. Thus, even though the wavelengths associated with a given object as it enters or exits the field of view of the scanning Fabry-Perot etalon camera are not known a priori, it is certain that each object is captured using all Fabry-Perot etalon gaps and thus all wavelengths in the spectral range. An algorithm is used to convert the signals from the image sensor (e.g., a monochrome sensor, a red/green/blue sensor, etc.) into spectral slices. The set of spectral slices associated with any given object are then reconstructed into a spectral image of the object that indicates the reflectance spectrum associated with the physical points of the object.

In some cases, no object tracking algorithm is utilized but instead the speed of the objects in the conveyor belt is known. Thus, the pixel distance traversed between gap steps is known so that corresponding points on objects are indicated by shifting consecutive images by a known number of pixels.

In some cases, rather than scanning the Fabry-Perot etalon with parallel mirror plates as described above, the Fabry-Perot etalon can be adjusted such that the mirrors are not parallel but instead are canted to form a smaller gap at one end and a larger at the other. The axis along which the gap changes is parallel to the motion of the substrate (e.g., a conveyer belt) described above, and thus each image captured contains a single line captured at each Fabry-Perot etalon gap of interest. By taking successive images in no more time than the object on the conveyor belt takes to pass from one Fabry-Perot etalon gap of interest to the next, a full set of gaps can be collected and the conversion algorithm applied to arrive at a set of spectral images. In some embodiments, a mixture of the canted mirror method and the coplanar mirror method is used.

In some embodiments, multiple Fabry-Perot etalon imagers are used together each to collect different parts of the desired set of gaps in the event that additional data collection speed is necessary.

A light source is coupled to a tunable-Fabry-Perot etalon imager or a Fabry-Perot Interferometer (FPI) assembly. In various embodiments, the light source is either a single or composite broadband source such as a halogen lamp, or the light source is an array of LEDs, either with a common on/off switch, or individually controlled.

The system includes optics, such as a lens to collimate the light from the light source such that it is sufficiently collimated when entering the Fabry-Perot etalon. In some cases, the system also includes a spatial filter, such as two irises properly sized and positioned to ensure that sufficiently collimated light passes through the Fabry-Perot etalon. In some cases, the spatial filter allows only the portion of the light which passes through the Fabry-Perot etalon, and which is sufficiently collimated, to be further processed by the system. In some cases, the Fabry-Perot etalon is placed in an image plane of the system, such that both the object of interest and the Fabry-Perot etalon are imaged onto the image sensor, and care is taken to match the numerical aperture of the system at the FPI with the desired spectral resolution of the camera.

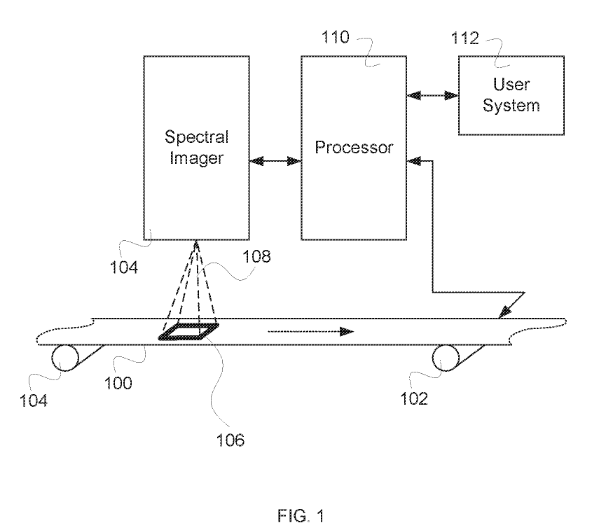

FIG. 1 is a block diagram illustrating an embodiment of a system for machine vision spectral imaging. In the example shown, substrate 100 (e.g., a conveyor belt) has objects that are moved relative to spectral imager 104. Imaging area 106 is projected along path 108 to image an area of substrate 100. Substrate 100 moves supported by roller 102 and roller 104. Processor 110 optionally provides instructions or control signals that set the speed of motion of substrate 100 relative to spectral imager 104. Processor 110 provides instructions and/or control signals to spectral imager 104 that collects the spectral images of objects on substrate 100. Spectral imager 104 takes a series of images each with different spectral sensitivity range as controlled by an adjustable filter (e.g., a Fabry-Perot etalon). A complete set of images that cover all desired adjustable filter settings are taken while an object is within imaging area 106. The time it takes for an object to traverse imaging area 106 is arranged to be less than the time it takes to take a complete set of images. Processor 110 corresponds spectral readings associated with the object of interest even though the object is moving within imaging area 106. This is achieved using image processing to identify corresponding object locations or through using the calculated position by knowing the substrate 100 speed with respect to spectral imager 104. User system 112 is provided a spectral image associated with objects on substrate 100.

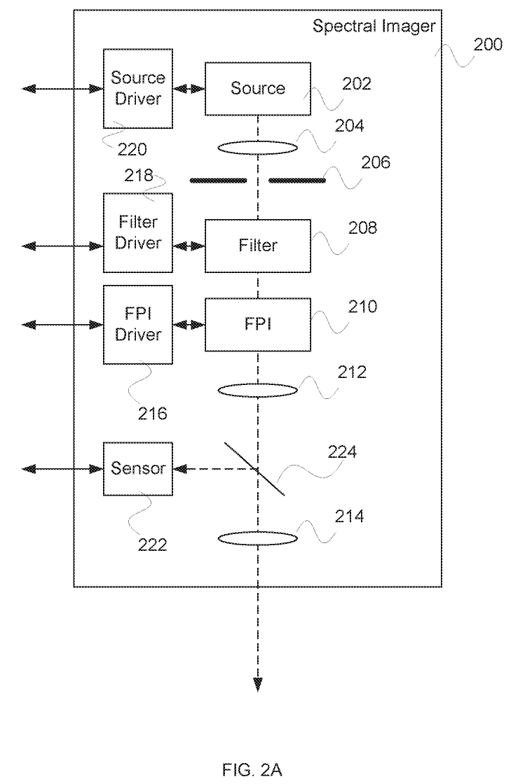

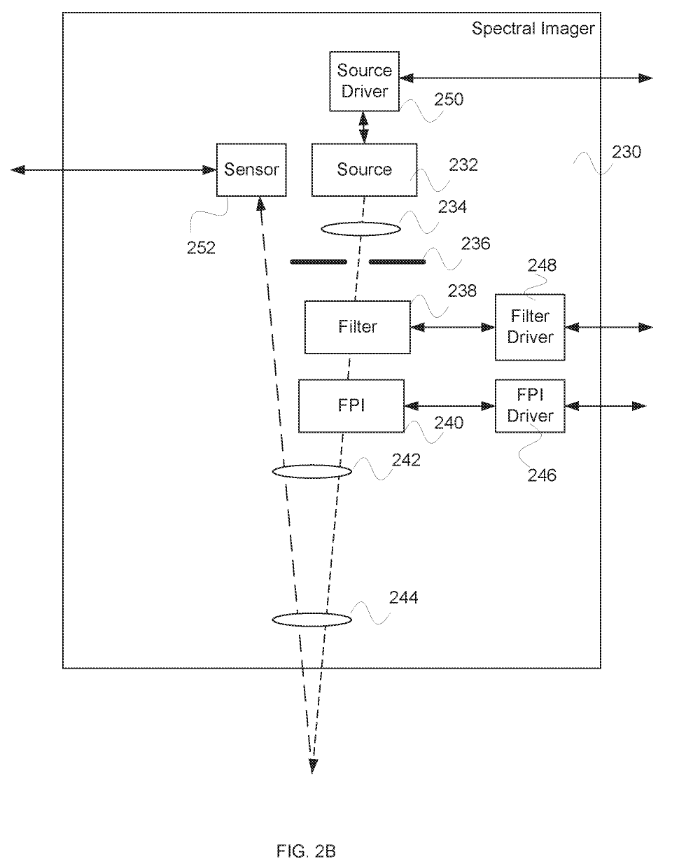

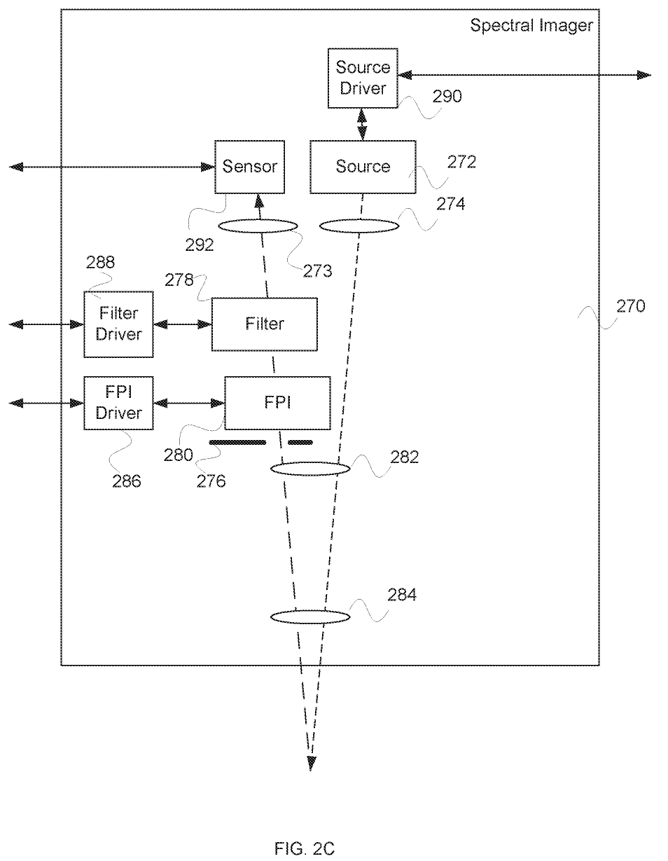

FIG. 2A is a block diagram illustrating an embodiment of a spectral imager. In some embodiments, spectral imager 200 is used to implement spectral imager 104 of FIG. 1. In the example shown, a control signal from a processor is received at source driver 220 and used to set source 202. Source 202 provides source illumination which passes through collimating optics 204 and aperture 206 to reach filter 208. Filter 208 provides coarse filtering and is adjustable using commands provided to filter driver 218. After filter 208, the light originating from source 202 passes through FPI 210 (adjustable Fabry-Perot interferometer or etalon) that is adjusted using a signal received at FPI driver 216. FPI 210 filters incident light down to one or more narrow bands, which are projected onto an imaging area using optics 212 and optics 214. FPI 210 is comprised of a pair of highly reflected mirrors of sufficient smoothness, planarity, and co-planarity with one or more actuators separating them. For example, the actuators may be piezoelectric crystals. FPI 210 may incorporate control electronics to ensure that its mirrors attain sufficient co-planarity across multiple gaps. Light is reflected back from the imaging area and directed toward imaging sensor 222 using beam splitter 224. Sensor 222 provides output images to a processor for analysis. The optical axis of the collimating optics (e.g., collimating optics 204 and aperture 206) coincides with the optical axis of FPI 210.

FIG. 2B is a block diagram illustrating an embodiment of a spectral imager. In some embodiments, spectral imager 230 is used to implement spectral imager 104 of FIG. 1. In the example shown, a control signal from a processor is received at source driver 250 and used to set source 232. Source 232 provides source illumination which passes through collimating optics 234 and aperture 236 to reach filter 238. Filter 238 provides coarse filtering and is adjustable using commands provided to filter driver 248. After filter 238, the light originating from source 232 passes through FPI 240 (adjustable Fabry-Perot interferometer or etalon) that is adjusted using a signal received at FPI driver 246. FPI 240 filters incident light down to one or more narrow bands, which are projected onto an imaging area using optics 242 and optics 244. FPI 240 is comprised of a pair of highly reflected mirrors of sufficient smoothness, planarity, and co-planarity with one or more actuators separating them. For example, the actuators may be piezoelectric crystals. FPI 240 may incorporate control electronics to ensure that its mirrors attain sufficient co-planarity across multiple gaps. Light is reflected back from the imaging area and directed toward imaging sensor 252. Sensor 252 provides output images to a processor for analysis.

FIG. 2C is a block diagram illustrating an embodiment of a spectral imager. In some embodiments, spectral imager 230 is used to implement spectral imager 104 of FIG. 1. In the example shown, a control signal from a processor is received at source driver 290 and used to set source 272. Source 272 provides source illumination which passes through collimating optics 274 to illuminate an imaging area. Back reflected light from the imaging area is captured using optics 284 and optics 282. The back reflected light is passed through aperture 276 to reach FPI 280 that is controlled using FPI Driver 286. After FPI 280 light is further filtered using filter 278 that provides coarse filtering and is adjustable using commands provided to filter driver 288. FPI 280 filters incident light down to one or more narrow bands, which are projected onto sensor 292 using optics 273. FPI 280 is comprised of a pair of highly reflected mirrors of sufficient smoothness, planarity, and co-planarity with one or more actuators separating them. For example, the actuators may be piezoelectric crystals. FPI 280 may incorporate control electronics to ensure that its mirrors attain sufficient co-planarity across multiple gaps. Sensor 292 provides output images to a processor for analysis.

Filter 208 or filter 258 may incorporate a fixed spectral bandpass filter (or a low pass and high pass combination which creates an effective bandpass filter)—for example in the case that the spectral band to be scanned is narrow or in the case in which an image sensor with a Color Filter Array is used. In some cases, instead of filter 208 or filter 258, or in addition to filter 208 or filter 258, there is a second FPI that acts as a gross tunable filter. The second FPI and FPI 210 is positioned such that they share an optical axis. Sensor 222 or sensor 272 may have fewer color filters or may be monochrome in the case of using a second FPI. In some embodiments, the two tunable FPIs share a center mirror that is coated on both faces but where each FPI may be controlled separately. In various embodiments, one or both tunable FPIs may be actuated by means other than piezoelectric actuators—for example, using a microelectromechanical system (e.g., by electrostatically changing the position of a membrane relative to a substrate), using acousto-optical actuators, or any other appropriate actuation. In some embodiments, the transmission bands passing through one or both FPIs may be controlled by changing the refractive index of the material between the mirrors—for example, by changing the voltage across a liquid crystal.

In some embodiments, suitable optics shape the output beam from FPI 210 or out of filter 258 into a narrow rectangular beam—for example, using one or more cylindrical lenses.

In some embodiments, the beam is focused on a plane which is orthogonal to the optical axis with an object moving relative to the beam. In some embodiments, the plane is a conveyor belt in a production line. As objects move on the conveyor belt, they cross the rectangular beam, whose long axis is perpendicular to the direction of motion. Light is reflected from these objects and is collected using standard imaging optics onto a linear or image sensor.

In some embodiments, the objects are static on the plane of the substrate, and the optical axis is scanned in a direction parallel to the plane—for example, using a mechanical actuator, such that the rectangular beam scans either parts of, or the whole plane.

In some embodiments, both the optical axis and the objects move.

In some embodiments, more than one transmission order is passed through FPI 210 or FPI 260 at a single gap and the relative intensities of these orders is determined using a sensor with a color filter array (CFA) and algorithms.

In some embodiments, either the scanned spectral range is sufficiently narrow such that only a single order is transmitted through FPI 210 or FPI 260 for each gap; or the gross FPI is scanned such that at each gap of FPI 210 or FPI 260 only one order is transmitted through FPI 210 or FPI 260. In this configuration, a monochrome sensor may be used.

In some embodiments, the imaging optics may image an object or a feature of an object onto one or more pixels on a first row of the image sensor as a moving object enters the camera's field of view. At that instant, FPI 210 or FPI 260 is set to a first gap which corresponds to a first illumination wavelength. The sensor images a rectangular region which includes the object or object feature. The digital numbers captured by the image sensor pixel, or pixels, and which correspond to light intensities at the various pixels, are saved to memory and indexed. FPI 210 is set to a second gap corresponding to a second wavelength while the object is at a second position and a second image is captured, indexed and stored. The system is designed (magnification and line speed) such that FPI 210 or FPI 260 completes a complete sequence of gaps while an object is within its field of view.

In some embodiments, without loss of generality, the objects on a plane are static and the optical assembly moves, but images are captured and indexed as above.

In some embodiments, the light source is comprised of a sufficiently spatially-localized array of narrow-band sources, which spans the whole scanning range. Sufficiently localized means that a sufficiently high portion of the light from the narrow-band sources may be sufficiently collimated before entering FPI 210 or FPI 260. In some embodiments, the array of narrow-band sources comprises an array of LEDs. In some embodiments, the array of LEDs is individually controlled, or controlled in groups, such that their switch-on and switch-off times are on the order of the dwell time of FPI 210 or FPI 260 in a given gap or group of gaps. In some embodiments, control electronics ensures that only a subset of the narrowband sources are illuminating during each FPI gap position; these subsets being defined so as to correlate with the spectral bands that are transmitted in each gap position.

In some embodiments, suitable optics collect the reflected light from the illuminated objects and focus them onto an image sensor (e.g., sensor 222 or sensor 272) such that a sufficient portion of the reflected light is focused onto the image sensor. In some embodiments, the image sensor is a linear sensor with more pixels in one axis than in the other. In some embodiments, the image sensor includes a color filter array. In some embodiments, the image sensor is a monochrome sensor. In some embodiments, the image sensor implements a global shutter configuration.

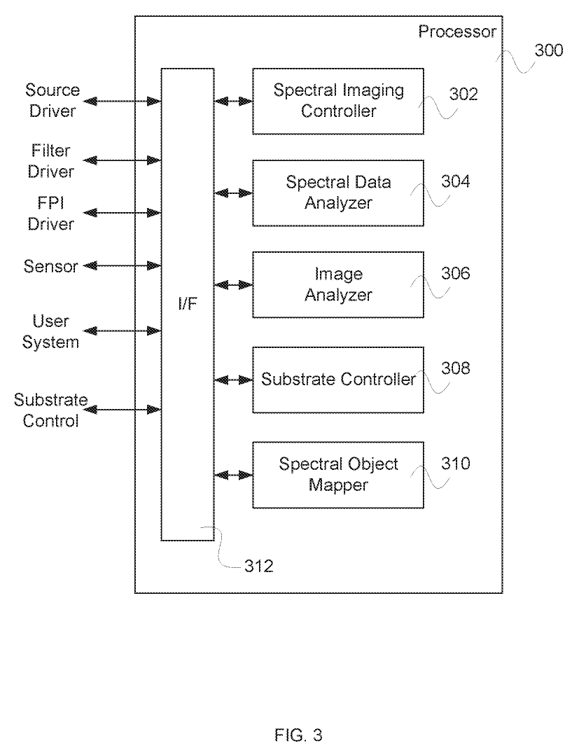

FIG. 3 is a block diagram illustrating an embodiment of a processor. In some embodiments, processor 300 is used to implement processor 110 of FIG. 1. In the example shown, spectral imaging controller 302 of Processor 300 indicates to source driver to turn on source for spectral imager and to control the source, if appropriate, as to which illumination to provide for the object. Spectral imaging controller 302 also sets filters by sending signals to filter driver and FPI driver. In some embodiments, spectral imaging controller 302 sets substrate speed using substrate controller 310 (e.g., with a suitably slow speed, synchronous or asynchronous to image collection). Spectral imaging controller 302 coordinates source signals, filter signals, FPI signals, and substrate signals to enable acquisition of a set of spectral images for an object carried by the substrate such that the object is imaged over a full set of filter settings to provide spectral reflectance information for generating a spectral map for the object. This is achieved by taking one spectral image after another while an object is in the field of view of the spectral imager and storing the resulting images with their associated illumination settings (e.g., a gap setting of the FPI, a filter setting, a source setting, etc.). These images and their settings can be used to determine a spectral map (e.g., by spectral data analyzer 304 and spectral object mapper 310). Spectral data analyzer 304, using the set of images and the associated setting information, outputs the spectrum associated with points in the image. Spectral object mapper 310 combines the spectrum information and object identification information (e.g., using image processing to determine objects) to determine a spectral map associated with the objects identified. The spectral map associated with the objects is provided to a user system via interface (I/F) 312. I/F 312 also provides an interface for other sub-units of processor 300 (e.g., spectral imaging controller 302, spectral data analyzer 304, image analyzer 306, substrate controller 308, and spectral object mapper 310). In various embodiments, processor 300 executes instructions for each of the sub-units, multiple processors execute instructions which combined perform the functionality for the sub-units described above, or any other appropriate combination of processor and instructions.

In some embodiments, processor 300 identifies, tracks, and indexes objects in the sequence of images. For example, in the event that the objects move in a linear fashion and at a known velocity with respect to the optical system, the images may be shifted by the number of pixels corresponding to the displacement of the objects between frames such that the objects then appear to be static. The index of each image is matched with one or more wavelengths based at least in part on the filter settings, FPI settings, substrate settings, and source settings.

In some embodiments, the intensity for each object within each monospectral image is normalized using a calibration table or using other methods such that the set of digital numbers is translated to photon flux or object reflectance. In this way, a spectrum is generated for each object passing through the field of view.

In some embodiments, quality control of scanned objects is achieved by setting acceptance limits to the values of digital numbers from the image sensor which correlate to specific gaps or gap combinations of the one or more FPIs in the spectral imager.

In some embodiments, the information about scanned objects is contained in the values of digital numbers from the image sensor, which correlate to specific gaps or gap combinations of the one or more FPIs in the spectral imager.

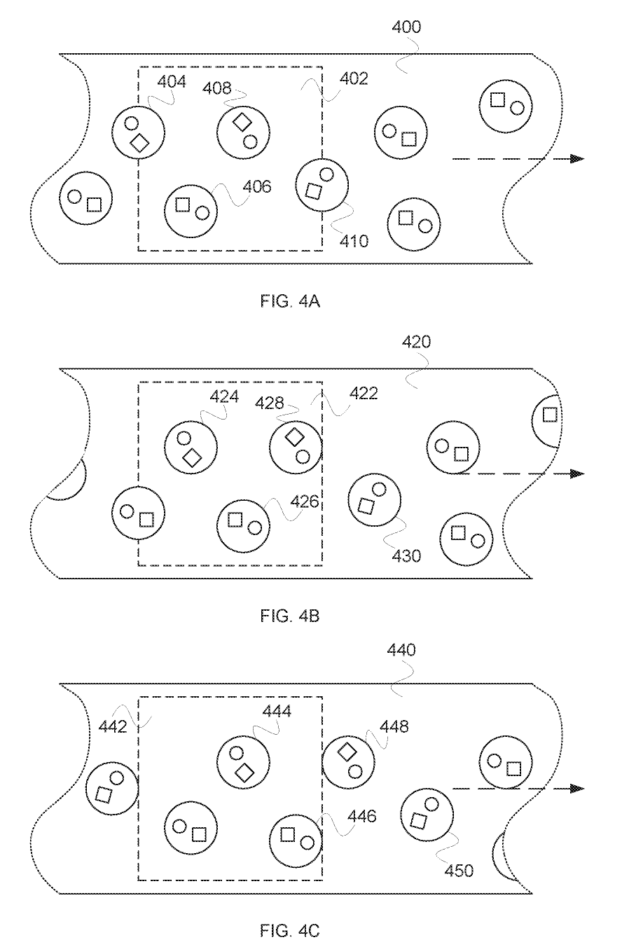

FIGS. 4A, 4B, and 4C are block diagrams illustrating objects moving on a substrate. In some embodiments, substrate 400, substrate 420, and substrate 440 are example views of objects on a substrate such as substrate 100 of FIG. 1. In the example shown in FIG. 4A, substrate 400 has area 402 that is imaged by a spectral imager as objects are moved by substrate 400 (e.g., a conveyor belt). Object 404 is entering area 402 as it moves left to right on substrate 400. Object 406 and object 408 are in area 402 as they move left to right on substrate 400. Object 410 is exiting area 402 as it moves left to right on substrate 400. In the example shown in FIG. 4B, substrate 420 has area 422 that is imaged by a spectral imager and objects that are moved by substrate 420 (e.g., a conveyor belt). Object 424 has entered area 422 as it moves left to right on substrate 420. Object 426 and object 428 are in area 422 as they move left to right on substrate 420. Object 430 has exited area 422 as it moves left to right on substrate 420. In the example shown in FIG. 4C, substrate 440 has area 442 that is imaged by a spectral imager and objects that are moved by substrate 440 (e.g., a conveyor belt). Object 444 is in area 422 as it moves left to right on substrate 440. Object 446 has now almost exited area 444 as it moves left to right on substrate 440. Object 448 and object 450 have exited area 442 as it moves left to right on substrate 440.

As an object (e.g., object 404) moves through area 402 a sequence of spectral images is taken such that by the time it traverses area 402 (e.g., object 424 within area 422 and object 444 within area 442) a full set of spectral images has been taken. A spectral image taken for the objects in positions associated with FIG. 4A are associated with one or more frequencies—set A. A spectral image taken for the objects in positions associated with FIG. 4B are associated with one or more frequencies—set B. A spectral image taken for the objects in positions associated with FIG. 4C are associated with one or more frequencies—set C.

Note that the even though an object will start within the area with a different spectral image, a full set of spectral images will still be taken. For example, suppose that a full set of spectral images comprises A, B, C, D, and E associated with the sets of frequencies set A, set B, set C, set D, and set E. Some objects will get images A, B, C, D, and E—some objects B, C, D, E, and A—some objects C, D, E, A, and B—some objects D, E, A, B, and C—and some objects will get images E, A, B, C, and D.

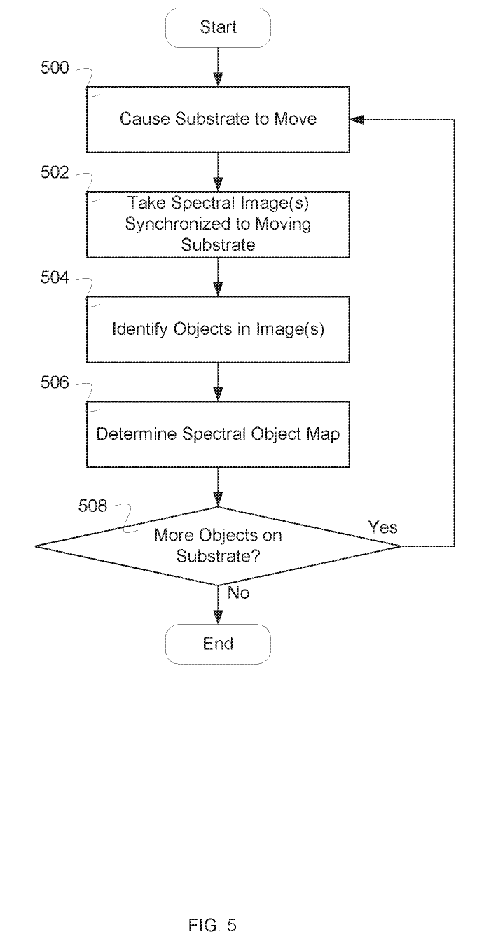

FIG. 5 is a flow diagram illustrating an embodiment of a process for machine vision spectral imaging. In some embodiments, the process of FIG. 5 is executed using processor 110 of FIG. 1. In the example shown, in 500, a substrate is caused to be moved. In 502, spectral image(s) are taken synchronized to the moving substrate; for example, a full set of images associated with different sets of frequencies to be able to generate spectral maps of the objects on the moving substrate. In 504 objects in the image(s) are identified. In 506, spectral object map(s) is/are determined. For example, the images are used and the identification of objects is used to determine a spectral map for each object. In 508, it is determined whether there are more objects on the substrate. In the event that there are more objects on the substrate, control passes to 500. In the event that there are not more objects on the substrate, then the process ends.

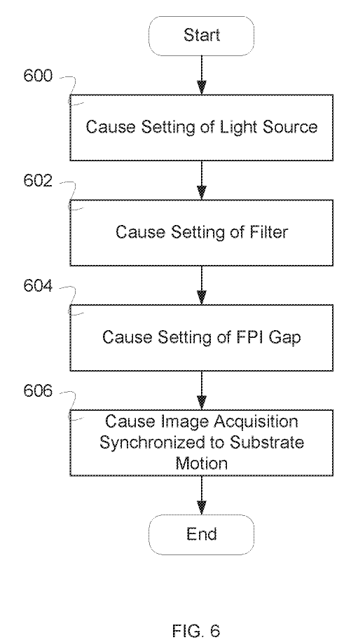

FIG. 6 is a flow diagram illustrating an embodiment of a process for taking a spectral image. In some embodiments, the process of FIG. 6 is used to implement 502 of FIG. 5. In the example shown, in 600, the setting of the light source is caused. For example, a light source is caused to be illuminated or set at a specific wavelength or set of wavelengths. In 602, setting of a filter is caused. For example, in the event that the filter comprises a coarse Fabry-Perot etalon filter, a gap is set. In 604, setting of an FPI gap is caused. In 606, an image is caused to be acquired synchronized to substrate motion.

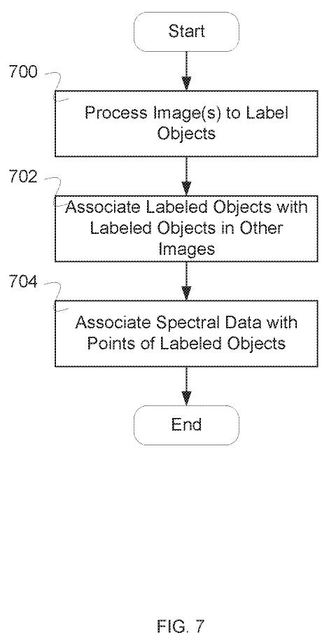

FIG. 7 is a flow diagram illustrating an embodiment of a process for determining a spectral object map. In some embodiments, the process of FIG. 7 is used to implement 506 of FIG. 5. In the example shown, in 700, image(s) is/are processed to label objects. For example, objects are identified in a given image. In 702, labeled objects are associated with labeled objects in other images. For example, a given object's image is identified in many images. In 704, spectral data is associated with points of labeled objects. For example, spectral information is associated with the points of an object.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for machine vision spectral imaging, comprising:
a spectral imager, wherein the spectral imager comprises a Fabry-Perot etalon including a settable gap;
a substrate, wherein the substrate has relative motion with respect to the spectral imager; and
a processor configured to:
identify an object in a set of images from the spectral imager, wherein each of the set of images is associated with a specific gap of a full set of gaps, wherein the full set of gaps comprises a set of gaps setting the settable gap covering a complete range of the settable gap needed for a full spectral image of the object.

2. The system as in claim 1, wherein the relative motion is such that the set of images is taken with the object in a field of view in each of the set of images.

3. The system as in claim 1, wherein the processor determines corresponding pixels for the is object in each of the set of images.

4. The system as in claim 3, wherein the full spectral image is constructed using the corresponding pixels for the set of images.

5. The system as in claim 3, wherein corresponding pixels for the object in each of the set of images is determined using image processing of the set of images.

6. The system as in claim 1, wherein the Fabry-Perot etalon is one of a plurality of Fabry-Perot etalons.

7. The system as in claim 1, wherein the Fabry-Perot etalon has parallel plates.

8. The system as in claim 1, wherein the Fabry-Perot etalon has a tilted plates adjusted so that the relative motion and the tilted plates compensate for each other.

9. The system as in claim 1, wherein the processor causes the relative motion.

10. The system as in claim 1, wherein the spectral imager comprises a broadband light source.

11. The system as in claim 10, wherein the broadband light source comprises a halogen source.

12. The system as in claim 1, wherein the relative motion is set so that the object is imaged using the spectral imager and each of the full set of gaps.

13. The system as in claim 12, wherein the settable gap is set in an increasing and then a decreasing gap width pattern over the complete range of the settable gap.

14. The system as in claim 13, wherein the increasing and then the decreasing gap width pattern comprises points along a triangle wave.

15. The system as in claim 13, wherein the increasing and then the decreasing gap width pattern comprises points along a sinusoidal wave.

16. A method for determining a calibrating spectral measurement, comprising:
providing a spectral imager, wherein the spectral imager comprises a Fabry-Perot etalon including a settable gap;
providing a substrate, wherein the substrate has relative motion with respect to the spectral imager; and
identifying, using a processor, an object in a set of images from the spectral imager, wherein each of the set of images is associated with a specific gap of a full set of gaps, wherein the full set of gaps comprises a set of gaps setting the settable gap covering a complete range of the settable gap needed for a full spectral image of the object.

17. A computer program product for determining a calibrating spectral measurement, the computer program product being embodied in a non-transitory computer readable storage medium and comprising computer instructions for:
receiving a set of images from a spectral imager; and
identifying, using a processor, an object in the set of images, wherein the spectral imager comprises a Fabry-Perot etalon includes a settable gap, wherein a substrate has relative motion with respect to the spectral imager, wherein each of the set of images is associated with a specific gap of a full set of gaps, wherein the full set of gaps comprises a set of gaps setting the settable gap covering a complete range of the settable gap needed for a full spectral image of the object.
